(19) United States
(12) Patent Application Publication
(10) Pub. No.: US 2024/0045078 A1
(43) Pub. Date: Feb. 8, 2024

(54) GLOBAL NAVIGATION SYSTEM/RADAR COMMON SIGNAL PROCESSING

(71) Applicant: Topcon Positioning Systems, Inc., Livermore, CA (US)

(72) Inventors: Leonid Victorovich PURTO, Moscow (RU); Dmitry Anatolyevich RUBTSOV, Moscow (RU); Andrey Vladimirovich VEITSEL, Moscow (RU)

(73) Assignee: Topcon Positioning Systems, Inc., Livermore, CA (US)

(21) Appl. No.: 18/006,877

(22) PCT Filed: Dec. 10, 2021
(86) PCT No.: PCT/RU2021/000564

§ 371 Date: Jan. 26, 2023

(51) Int. Cl. G01S 19/25; H04B 17/364

(52) U.S. Cl. CPC G01S 19/256; H04B 17/364

(57) ABSTRACT

A method and apparatus for processing global navigation satellite signals, or radar signals, specifies an arrival time of a signal having a shape similar to a known pseudo-random noise sequence (PRN) of rectangular pulses. Two quadrature signals are generated and six correlations are calculated and multiplied by a correlation coefficient. The results of one of quadrature signals are summed and a timing error is estimated. An improved signal arrival time is generated by adding the estimated timing error to the predicted signal arrival time is generated.

### FIELD OF THE INVENTION

The present disclosure relates generally to a method and apparatus for signal processing and, in particular, to signal processing for global positioning satellite systems or radar.

### BACKGROUND

Early applications of high-precision global positioning satellite systems such as GPS and GLONASS (See, for example, “Understanding GPS. Principles and Applications” by Elliott D. Kaplan and Christopher J. Hegarty.) provided a user with long-range signals having simple structures for use with low chip rates. In later applications, shaped signals having bandwidths that were ten times as wide as the signals used in the early applications were added to the signals used in the early applications. Also, the combination of global positioning with local positioning began to be actualized, with the local positioning using ultra-wide band (UWB) signals. Development of global and local positioning systems has resulted in simultaneous positioning with radio navigation and 3D environmental control using high resolution radars. Many radar and positioning systems are based on direct spread spectrum signals, also known as pseudo-random noise (PRN) signals, with a PRN sequence of rectangular pulses (referred to as chips) wherein the polarity of the pulses is determined based on the sequence. The similarity of signals and solving tasks often results in implementation of a navigation receiver and a radar in the same device based on the similar universal components required for digital signal processing. To achieve a desired level of user and cost performance, processing methods for navigation and radar signals, as well as apparatuses for their implementation, have common structures and can be implemented in a single mechanism.

### SUMMARY

In one embodiment, a method of specifying an arrival time of a radio signal having a shape similar to a known pseudo random noise (PRN) sequence of rectangular pulses moved on a radio frequency, the method includes the step of generating two quadrature signals by multiplying the signal by a carrier. A PRN sequence of shortened pulses related to the known PRN sequence is synthesized. Six correlations of a moved-to-zero frequency signal with the synthesized PRN sequence are then calculated and each correlation result is multiplied by a correlation coefficient. The multiplied correlation results for one of the two quadrature signals are summed and a timing error that is an error of signal arrival time relative to a predicted arrival time based on the result obtained for the quadrature of the signal is estimated. An improved signal arrival time is generated by adding the estimated timing error to the predicted signal arrival time, wherein the six correlations and respective six beginning time moments related to them form two groups of three correlations, the two groups of three correlations having one of the boundaries of the shortened pulses of a first correlation in each of two groups matching one of boundaries of the pulses in a received signal, a second boundary of shortened pulses of the first correlation coinciding with one of shortened pulse boundaries of the second correlation, the time interval between neighboring boundaries of shortened pulses of the second and third correlations, as well as the time interval between neighboring boundaries of shortened pulses of the first and third correlations being longer than the duration of the shortened pulses of the third correlation, a difference between beginning time moments of first, second, and third correlations of the first group and the predicted arrival time by modulo is equal to the difference between the predicted arrival time and beginning time of the first, second, and third correlations of the second group and the absolute values of a first, second, and third coefficients by which the first, second and third correlations from the second group are multiplied when adding being the same as the absolute values of the first, second and third coefficients by which the first, second, and third correlations from the second group are multiplied, but signs of the coefficients by which correlations from the first group are multiplied being either the same as the signs of all the three coefficients by which the correlations from the second group are multiplied, or opposite to the signs of coefficients by which the correlations from the second group are multiplied.

In one embodiment, a method for specifying an arrival moment of a radio signal with a known PRN sequence of rectangular pulses into a navigation receiver or radar. The method includes the step of determining a timing error of an estimated moment of signal arrival by the sum of correlations of six portions of the received signal, calculated as three pairs of correlations, where each portion corresponds to the use in each of the six correlations of a part of the energy of rectangular pulses and the non-use of the signal in this correlation for the remaining time, and, in the third pair of correlations, each correlation uses a short pulse fragment far from the pulse border, in the first pair of correlations, each correlation uses the first long pulse fragment adjacent to the border of the pulse, and in the second pair of correlations, the second long fragment of the pulse between the fragments of the pulse used in the correlations of the first and third pairs, while the second long fragment of the pulse is adjacent to the first long fragment and is at a distance from the short fragment of pulse. When receiving a signal formed as a single carrier signal, the received signal is correlated with a differentiated version of the known PRN sequence, when in the first correlations from each pair, portions of the signal from the first half of the pulse are used, in the second correlations from each pair, fragments of the signal from the second half of the previous pulse are used, and when correlations in each pair are summed with those of the same signs, the total result of the second and third pairs is added with one sign, and the total result of the first pair is added with a opposite sign. While receiving a signal formed as a signal with two subcarriers, the received signal is correlated with the known PRN sequence, all the correlations use fragments of the signal from the first half of the pulse, and the known PRN in the first correlations of each pair is correlated with the first subcarrier, and in the second correlations with the second subcarrier, while the correlations in each pair are added with opposite signs, the total results of each pair are added with the same signs, the total result of the first pair is added with a larger weight.

In one embodiment, an apparatus comprises a correlator specifying a time of arrival of a radio signal similarly shaped to a known PRN sequence of rectangular pulses in a receiver or a radar. The correlator includes a mixer configured to receive a signal at an input, and transmit two quadrature signals from an output. The correlator also includes a plurality of memory elements each configured to store one of a plurality of coefficients. A comparison unit having four time thresholds and four states at its output, wherein at the output there is generated a first state, if the input value is less than a first threshold, or at the output there is generated a second state, if the input value is less than a second threshold, or at the output there is generated a third state, if the input value is between a third threshold and a fourth threshold, otherwise, zero state is generated at the output. A commutation unit is configured to select one of the plurality of coefficients or zero depending on the state at the output of the comparison unit. An NCO is configured to count integer and fractional part of a chip number in an epoch. A fractional extraction module is configured to take the fractional part of the chip number and subtracting 0.5 from it, thereby counting time after the front during the first half of the chip from 0 up to +0.5, and during the second chip half from −0.5 up to 0. A unit is configured to calculate modulo of a signed number. The apparatus also includes a code generator and a first multiplier configured to calculate a multiplication product of a code generator's output signal, a mixer's output signal, and a commutation unit's output signal. An accumulator is configured to accumulate results for one quadrature being chosen, the quadrature chosen being the output of the correlator, wherein, the output of the first multiplier is added in the accumulator, NCO output is connected to the code generator and to the input of the fractional extraction module, the output of the fractional extraction module is connected to a unit of modulo computation, and its output is fed to the input of the comparison unit.

### BRIEF DESCRIPTION OF THE DRAWINGS

FIG. 1 shows a first example of a waveform comprising late and early correlations;

FIG. 2 shows a second example of a waveform comprising late and early correlations;

FIG. 3 shows a third example of a waveform comprising late and early correlations;

FIG. 4 shows a fourth example of a waveform comprising late and early correlations;

FIG. 5 shows a fifth example of a waveform comprising late and early correlations;

FIG. 6 shows a problem for a wideband Galileo E5A or E5B signal that is the focus of various embodiments;

FIG. 7 shows a possible arrangement of shortened pulses in a first, a second and a third correlation according to an embodiment;

FIG. 8 shows sections of a function for a signal according to an embodiment;

FIG. 9 shows a first function multiplied by a coefficient according to an embodiment;

FIG. 10 shows a second function multiplied by a coefficient according to an embodiment;

FIG. 11 shows a graph of a formula according to an embodiment; and

FIG. 12A-12D shows an apparatus and components of the apparatus according to various embodiments.

### DETAILED DESCRIPTION

One of the difficulties in determining the exact time of arrival of a long-range line-of-sight signal with limited spectrum is observed multipath which occurs when several copies of the desired signal are reflected from different obstacles and arrive at a receiver with a delay. Similar problems can occur when a radar searches for a nearest object. In such cases, one needs to determine the true delay of the signal reflected from the object against the background of arriving delayed reflections from other objects. Different methods are used for multipath mitigation and better delay resolution.

U.S. Pat. No. 5,495,499 to Patrick Fenton et al. describes a method and apparatus thereof wherein early and late wide-spacing correlators (for example, spacing is one chip in width) are used to specify the moment of a signal arriving. Such an embodiment provides a reliable DLL convergence after signal acquisition. One drawback of this implementation is a considerable impact of delayed signal copies (e.g., due to multipath) on the result of convergence. The more delay there is, the more deteriorated the result will be. If the desired signal and its Td-delayed copy are in-phase with respect to power, then the output of the early-late discriminator will be zero at an error (in other words, at a bias) of the predicted beginning of the signal arriving by a modulo equal to approximately Td/2. As a result, the receiver's navigation task or radar's measurement processing system obtain incorrect (e.g., distorted) information.

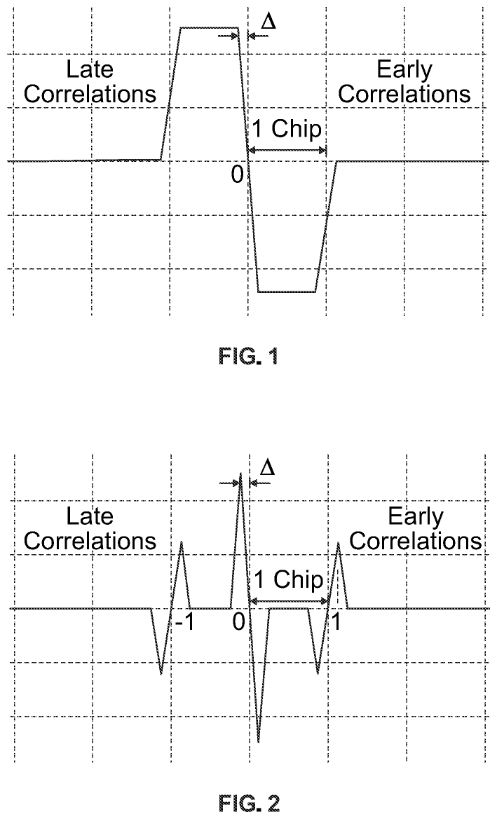

Another embodiment is referred to in various literature as narrow early-late correlators. In this embodiment, the spacing between early and late correlators calculated as 2*Δ being essentially smaller than the duration of one chip. The discriminator characteristic formed by this correlator is linear only if the signal arrival moment is shifted no more than by Δ. If the error |Td|>Δ, then the discriminator output will be the same as at |Td|=Δ. Due to this fact, the influence of delayed signal copies is stopped as the delay increases. Nevertheless, this influence is still significant. For example, if the desired signal is slightly more powerful than the delayed copy, and |Td|>Δ, then at the early-late discriminator output will be zero when the signal arrival moment is shifted approximately by Δ (by modulo). FIG. 1 shows a waveform comprising late and early correlations.

Both wide and narrow early-late correlators can be implemented using one of two methods. According to a first method, early and late correlations are calculated separately, and a difference value of early-late is calculated at once. In the second method, the input signal is correlated with a synthesized PRN in the form of a sequence of shortened rectangular pulses, which is equivalent to the difference between non-delayed and delayed by 2*Δ copies of the known PRN sequence. In this second method, the origin of the shortened pulses is in advance of the expected beginning of the corresponding pulses in the receiving signal by Δ.

Published International Application No. WO1997006446A2 describes an embodiment wherein a synthesized PRN is generated as strobes located at the boundary of pulses of a known binary type PRN sequence on the condition that the two elements of the PRN sequence determining the polarity of neighboring pulses are different. Since the known PRN sequence consists of elements −1 and +1, different values of the neighboring elements of the known PRN sequence corresponds to negative or positive fronts in the received signal. The shortened pulses, whose polarity is determined by the synthesized PRN sequence start earlier than the expected moment of an arriving front by value Δ and stop later than the front arriving by value Δ.

An embodiment of this method, known as the “double delta discriminator”, estimates the offset of the expected time of signal arrival using two early and two late correlations. The original correlation moments are arranged and the correlation results are added as follows: first early and late correlations are spaced by Δ′, whereas the second early and late correlations are spaced by Δ″. At Δ″=2*Δ′, the equivalent strobe correlator according to this method can be presented as a sum of four correlators, and the correlation calculated by them as a sum of four correlations, with each correlation being a convolution of the received signal with the synthesized PRN fully matching the synthesized PRN of the first embodiment multiplied by shortened rectangular Δ′-duration pulses. In this case, the beginning moments of the four correlations have four values in increments of Δ′. Note that correlations with the earliest and the latest beginning moments are added with one sign, while the other two correlations are added with the opposite sign.

There are a number of alternative descriptions and implementation of the method described above. For example, as described in U.S. Pat. No. 5,963,582, a key parameter of a double delta discriminator as described therein is its discrimination characteristic of the following type: linear dependence of the discriminator output on Td at |Td|<Δ, and zero value at |Td|>2*Δ. At T−Δ>|Td|>T+Δ, where T is the duration of pulses (chip) of the received signal, the discriminator characteristic reproduces the characteristic in the vicinity of Td=0 at the coefficient of proportionality −0.5. FIG. 2 shows a waveform comprising late and early correlations and affected by the linear dependence discrimination characteristic.

The advantage of this method is the discriminator's insensitivity to copies of the desired signal with delays more than 2*Δ outside the range T−Δ . . . T+α. However, as previously stated, at |Td|>2*Δ, which is a considerable synchronization error, the discriminator is incapable of determining the value and sign of the error in the expected moment of signal arrival. Moreover, due to imperfections in the RF part at a shifted value of that magnitude, the output characteristic has a pulsing mode instead of a strictly zero value and it has multiple zero crossings which results in false steady states. This problem is especially noticeable for reception of wideband and ultra-wideband signals.

The influence of signal copies with delays in the range T−Δ . . . T+Δ, as well as the danger of leaving the working discriminator zone, is extremely important to consider in operation with ultra-wideband signals (UWB), because, such signals, when the delay is changed by one chip, the corresponding change in distance is less than 1 m.

Since delayed signal copies affect the result proportionally to the discriminator characteristic only in the zone of early correlations, for some embodiments, the moment of signal arrival is considered not for Td=0, but for Td′=0, where Td′=Td−1, or for Td=+1 which is the same. In this case, the influence of T-delayed signal copies is eliminated, but the other problems remain.

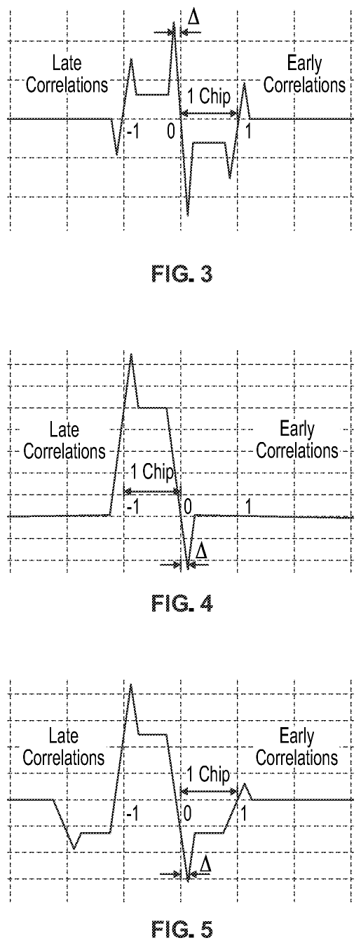

Another approach considers that Δ′<Δ″<2*Δ′. The discriminator characteristic is generated at 2*Δ<|Td|<T−2*Δ and has value determined by the difference 2*Δ′−Δ″ instead of zero. FIG. 3 shows a waveform according to this approach comprising late and early correlations. This approach is an intermediate version of a simple narrow early-late correlator and a double delta correlator. From the point of tracking the desired signal delays, this implementation is an improvement over many other methods, because there is no insensitivity zone within limits of T, but with respect to the effects of delayed copies, the discriminator's properties become worse. This implementation, with the correlator synchronized not for Td=0, but for Td=+1, that is, when protection from the delayed copies is greatest, still produces a minimal advantage. This is because of the insensitivity of the discriminator to bias Td in a direction to an early position.

U.S. Pat. No. 6,272,189 discloses another method wherein a strobe correlator implements four correlations in which the shortened pulses are symmetrically spaced relative to the fronts of the received signal. These symmetrically spaced shortened pulses are similar to the pulses described in Published International Application No. WO1997006446A2. In this method, two of the correlations most spaced apart are added with opposite signs. In a number of embodiments, said strobes are located not only at fronts, but also at places where neighboring elements of the known PRN sequence are equal. In other words, the synthesized PRN sequence is equal to the original known PRN sequence. Note that discrimination characteristic in this case has complex, non-symmetrical form. FIG. 4 shows a waveform comprising the late and early correlations with the discriminator characteristic at Td>2*Δ being equal to 0.

If four correlations are added, the discriminator characteristic at Td>2*Δ is equal to 0. As such, delayed signal copies, delayed also by value T, do not negatively affect the result. Noise parameters of the discriminator are 3 dB better and synchronized relative to Td=+1 in the above considered method described in Published International Application No. WO1997006446A2, but they are 3 dB worse and synchronized relative to Td=0. One of the disadvantages of this method is its insensitivity to bias estimates for moments of signal arrival when these moments are shifted more than by 2*Δ. Another disadvantage is difficulty in applicability of such a correlator to Binary Offset Carrier (BOC) type signals. FIG. 5 shows a waveform comprising the late and early correlations when BOC type signal is received.

From the FIG. 5 one can conclude that the only possible working point in the correlator's discriminator characteristic of the given structure is Td=+1. This implementation results in obtaining noisier results. In addition, the problem of adjusting the expected moment of signal arrival at positive Td and a value greater than the selected working point by 2*Δ is still not solved.

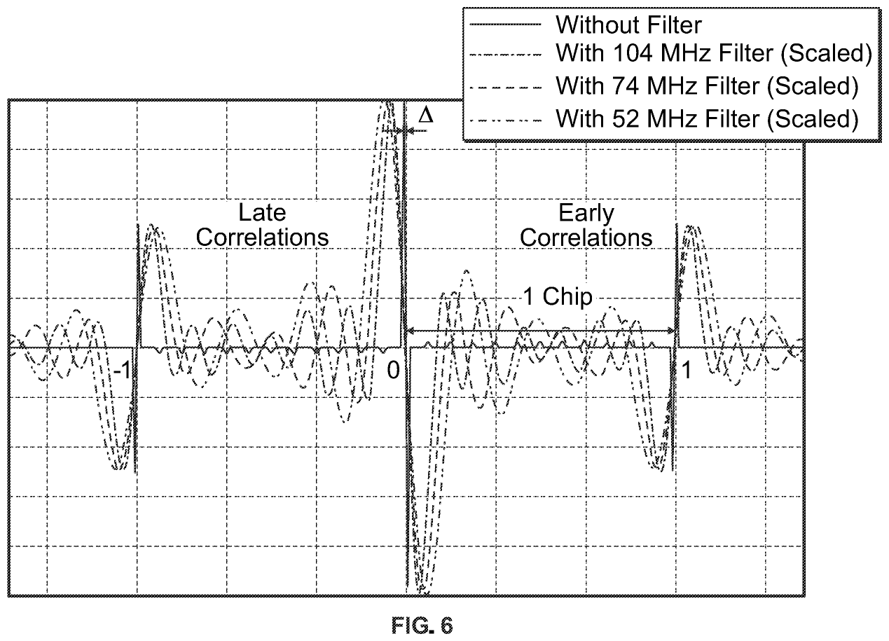

A common drawback of the methods described above is their incapability of diminishing negative effects of delayed copies at delays smaller than Δ. A decrease in the value Δ is limited by at least two factors: the problems caused by leaving discriminator's working zone (2*Δ), and the effects related to a limited bandwidth of the RF part. A restriction of signal bandwidth results in smoothing fronts and, hence, in stopping the reduction of the discriminator's sensitivity zone, even if parameter Δ becomes sufficiently small. FIG. 6 shows the problem for a wideband Galileo E5A or E5B signal.

U.S. Pat. No. 8,571,088 describes a method often referred to as Multipath Estimating Delay Lock Loop (MEDLL), according to which expected moments of desired signal arrival are estimated, and together with this, the availability of delays of different copies of the same signal is determined. The shape of the correlation peak of the input signal is thoroughly measured, and impulse response characteristic (IR) of a channel is estimated according to this shape. Then, the moment that the earliest signal copy arrives, which is the desired signal, is determined in accordance with the IR. Due to theoretical limitations of this method, some assumptions are used in its implementation. For example, the desired signal is regarded as the most powerful among all the received copies. There are different implementations of this method. For specific conditions, which should be considered as ideal or simplified, this method can produce a better result than methods described above. If these conditions are not satisfied, this method wrongly estimates the IR and hence the result becomes worse. Among conditions which worsen the result are: complex structure of the received signal, large power of delayed signal copies, distortion of the RF part, movements of receiver and/or reflecting objects, and noise. One drawback of this method is also the need of large number correlators to measure correlation characteristic of the signal in details.

An additional possibility that can be realized with additional difficulty pertains to the reception of BOC signal. Autocorrelation characteristic of such a signal has some peaks, which makes the determination of the moment that the signal arrives more difficult due to possible errors in selecting a correlation peak but it improves multipath mitigation, because correlation peaks in the BOC signal are sharper.

U.S. Patent Application Publication Numbers 2009/0207891 and 2017/0078083 describe methods according to which multipath estimation is implemented by analyzing the difference of peak amplitudes of the correlation characteristic, as well as analyzing time moments of zero crossings by the correlation characteristic. The advantage of this method is the use of BOC benefits MEDLL conception. However, this method includes the drawbacks described above for MEDLL.

The BOC signal can be considered both as a signal formed on a single carrier and as a signal formed on two sub-carriers. Minimal bandwidth of RF part to receive BOC signals is much wider than for signals without sub-carriers at the same chip rate, which makes the use of BOC signals in radars with active electronically scanned phased array antenna systems and big numbers of narrow RF paths much more complicated. Difficulty of using the method described in U.S. Patent Application Publication Numbers 2009/0207891 and 2017/0078083 and a number of similar methods to track signals with several sub-carriers (signals different from BOC, for example, signals with small spacing of carriers) is a real disadvantage of the mentioned methods.

U.S. Pat. No. 8,964,813, European Patent No. EP2413160, and Borio, D., “Double Phase Estimator,” Inside GNSS, May/June 2015, disclose methods referred to as a Double Estimator and a Double Phase Estimator, wherein the time of an incoming BOC signal is specified using two tracking systems: a traditional DLL and additional SLL (Subcarrier Lock Loop) or SPLL (Subcarrier Phase Lock Loop). For adjustment, the additional lock loop uses an estimate of signal arrival time based on correlations other than the correlations used in DLL adjustment. The synthesized PRN sequence of rectangular pulses for correlators in some BOC signals is orthogonal to the pulses of the known original PRN. The PRN for such additional lock loop is implemented based on the properties of the modulating signal the sub-carriers arise from and also takes into account PRN for the DLL correlator such that effects of the modulating signal are eliminated. The results of loop operation mutually influence each other according to an algorithm. These methods reduce the probability of a false selection of BOC correlation peak and at the same time decrease noise (jitter) of the loop. However, these methods possess the drawbacks described with respect to narrow correlators and double delta correlator.

The complexity of isolating the first signal in time with the background of powerful delayed copies is especially evident when reflected signals are received by vehicle's radars. Many non-correlated signals similar to navigation satellite signals need to be used in high-resolution radars with controlled scan angle during simultaneous scanning and/or object tracking at different angles. There are some peculiarities with respect to processing radio signals in radar systems, even if they are similar to navigation signals: 1) signals with larger delays and thus of less interest can be more powerful than the first (i.e. most interesting) signal in time; 2) time for acquisition and specifying signal delay in the process of tracking is limited; 3) high dynamic; 4) mutual correlation of the desired signal with analogous signals reflected from different objects in other directions and not suppressed by the antenna system.

When radars use an active phased array with scanning in one or two planes, it means that a great number of cheap mixers are available in design which limit signal bandwidth by digital synthesis. Another limitation of the bandwidth is the difficulty in antenna focusing for ultra-wideband signals. These circumstances require the radar to increase the range resolution not only by expanding the bandwidth, but also by mitigating the multipath in the same way as it is done when receiving satellite signals having a smaller bandwidth.

A method according to an embodiment specifies the moment of arrival of a radio signal closely shaped as the known PRN consisting of rectangular pulses on one or some sub-carriers into navigation receiver or radar, and generates a discriminator characteristic which: retains the ability of DLL adjustment at large errors, unless they exceed a threshold; maintains anti-multipath properties of double delta correlators in reception of one-carrier signals; and provides an improved multipath mitigation in operation with signals with two and more sub-carriers.

To achieve the desired result, the following actions are performed according to an embodiment: the received signal is multiplied by a carrier and two quadratures are obtained; a PRN sequence of shortened rectangular pulses is synthesized which is related to the known PRN sequence; six correlations of the quadrature signal and the synthesized PRN are identified and counted; each correlation result is multiplied by a coefficient, with the results for one quadrature summed; an estimate of biasing the moment of signal arrival relative to the predicted arrival moment (hereafter—timing error) is calculated based on the obtained result for one quadrature; and a rectified moment of signal arrival is calculated by adding the estimated bias to the predicted time moment.

Six correlations and six related original time moments form two corresponding groups of three correlations, hereafter referred to as the first correlation, the second correlation and the third correlation. Part of the parameters of first correlations in each two groups is common for these correlations. Similarly, some parameters of second and third correlations are common for both groups.

Common correlation parameters in each group are: durations of shortened pulses for first, second, and third correlations designated as T₁, T₂ and T₃ correspondingly; and absolute values of differences t10=|t1−t0|, t20=|t2−t0|, t30=|t3−t01, where t1, t2, t3 are moments of beginning of the first, second, and the third correlations of each group, and t0 is the expected moment of beginning signal arrival.

Parameters t1, t2, t3 are associated with the centers of the shortened pulses of the first, second, and third correlations of the given group, and t0—with the beginning of the pulse of the received signal.

Each of the six correlations is calculated as follows:

$${S}_{g , i} = {\sum }_{k = 1}^{N} {\int }_{- ∞}^{∞} s ( t ) * {F}_{g} ( t ) * P ( k ) * rect ( t - T 0 * ( k - 1 ) - {t}_{g , i} - \frac{{T}_{i}}{2} , {T}_{i} ) * \partial t \qquad ( 1 )$$

where:

index g=1 . . . 2 determines the number of the first or second group;

index i=1 . . . 3 determines the number of the first, second or third correlations;

t is the time;

s(t) is the input signal;

F_{g}(t) is the non-modulated sub-carrier with index g;

P(k) is the element of the synthesized PRN sequence with number k;

T0 is the pulse duration in the received signal;

Tᵢ is the duration of the shortened pulse in correlated with number i;

t_{g,i} is the beginning moment for the correlation with number i from the group with number g;

rect(t,limit) is the function returning 1 at 0≤t≤limit; and

N is the length of the known PRN sequence which is also equal to the length of the synthesized PRN sequence.

All shortened pulses with a given number from the first, second, and third correlations of each group are entirely on one side of the assumed boundary between any adjacent pulses in the received radio signal, and also on the same side of the assumed midpoint of any of the received signal pulses, which is reflected in the following equations:

$$\{ \begin{matrix}{t}_{g , 1} = t 0 + {sign}_{t} ( g ) * t 10 \\ {t}_{g , 2} = t 0 + {sign}_{t} ( g ) * t 20 \\ {t}_{g , 3} = t 0 + {sign}_{t} ( g ) * t 30\end{matrix} \qquad ( 2 )$$

where function signₜ(g) returns +1 or −1 depending on value g.

In a number of embodiments, considering the primary signal transfer to the zero frequency, the sub-carriers relate as follows: F₂(t)=−F₁(t). At zero original phase it can be written as:

F_{g}(t)=F(sign(g−1.5)*t) (3)

where

F(t) is one of non-modulated sub-carriers after moving to zero of the central carrier frequency;

sign(g) is the function which returns either +1 or −1 depending on the sign of the argument.

The specifications of formula (1) can be re-written in the form:

$${S}_{g , i} = {\sum }_{k = 1}^{N} {\int }_{- ∞}^{∞} s ( t ) * F ( sign ( g - 1.5 ) * t ) * P ( k ) * rect ( t - T 0 * ( k - 1 ) - ( t 0 + {sign}_{t} ( g ) ) * {t}_{i , 0} - \frac{{T}_{i}}{2} , {T}_{i} ) * \partial t \qquad ( 5 )$$

where t_{i,0}=t10 at i=1, or t20 at i=2, or t30 at i=3.

It should be noted that reception of a signal without sub-carriers function F(t) turns into a constant not depending on t. In this case, when receiving single carrier signals, it is defined that function signₜ(1)=−signₜ(2), and when receiving signals with sub-carriers, signₜ(1)=signₜ(2). For some embodiments, parameter t−t0 is transmitted in function Fg(t) and F(t) of formula (1) and correspondingly of formula (5) instead of parameter t.

Results of six correlations are multiplied by coefficients and added according to the following formula:

S=Σ_{g=1}²Σᵢ₌₁^{g}S_{g,i}*w_{g,i}=Σ_{g=1}²Σᵢ₌₁^{g}S_{g,i}*sign_{w}(g)*wᵢ (6)

where

w_{g,i} is the correlation coefficient with number i from the group with number g;

wᵢ is the nominal value of the correlation coefficient with number i;

sign_{w}(g) is the function which returns +1 or −1 depending on value g;

When receiving a signal without sub-carrier, function sin g_{w}(1)=sin g_{w}(2), and when receiving signals with sub-carriers sin g_{w}(1)=sin g_{w}(2).

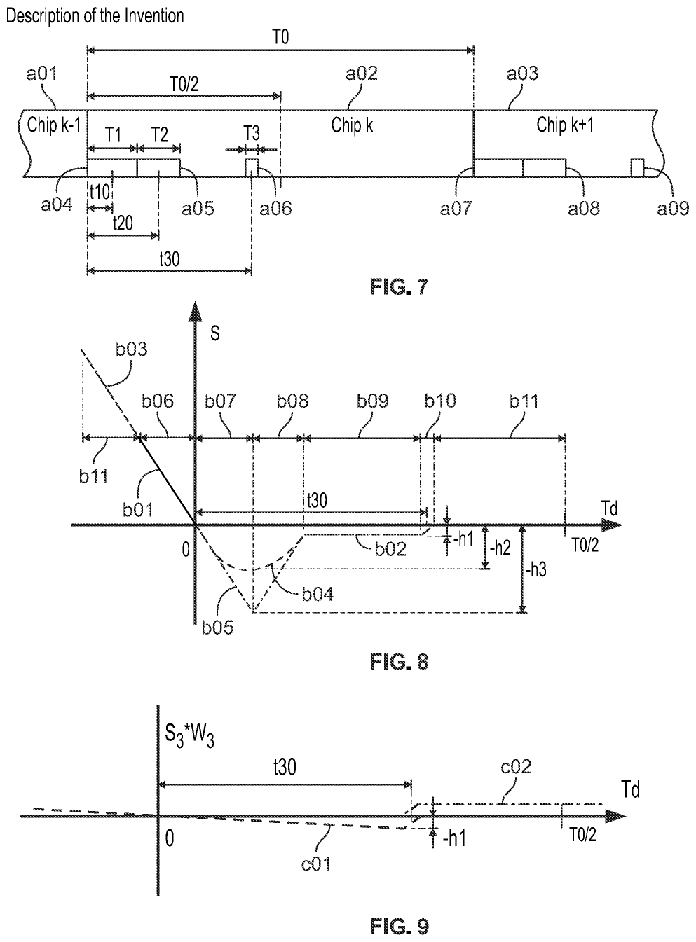

Note that parameters T₁, T₂, T₃, t10, t20, t30 are selected considering the following conditions: shortened pulses with number k in the first and second correlations of each group are adjacent to each other and have a common boundary, one of the boundaries of the shortened pulses of the first correlation matching the boundary of pulses in the received signal; the shortened pulses with number k in the third correlation of each group do not cross and do not have a common boundary with the shortened pulses of the first and second correlations, the time interval between neighboring boundaries of the shortened pulses of the second and third correlations, as well as the time interval between adjacent boundaries of shortened pulses of the first and third correlations being longer than the duration of the shortened pulse of the third correlation; and all the shortened pulses with the given number k in the first, second, and third correlations of each group are entirely on one side of the assumed boundary between any adjacent pulses in the received radio signal, and also on the same side of the assumed midpoint of any of the received signal pulses. A possible arrangement of shortened pulses in the first, second and third correlations of one of the groups is shown in FIG. 7.

Shortened pulse a04 with number k in the first correlation has a boundary matched with boundary of pulse a02 of the received signal. This shortened pulse also has a common boundary with shortened pulse a05 with the same number k in the second correlation. Shortened pulse a06 with number k in the third correlation is separated from pulse a05 by a considerable time interval. All the listed shortened pulses are arranged between the beginning and midpoint of pulse a02 of the received signal. Time boundaries of shortened pulses a07, a08 and a09 with numbers k+1 in the first, second, and third correlations are determined in a similar way.

For some embodiments, when receiving signals without sub-carriers, elements P(k) in the synthesized PRN sequence are determined according to the following formula:

$$P ( k ) = \frac{PRN ( k + z + 1 ) - PRN ( k + z )}{2} \qquad ( 7 )$$

where PRN(k) are the PRN elements of the received signal, and z is a constant equal to −1, 0 or +1.

For some embodiments, division by 2 in formula (7) is not performed.

Obtained P(k) components form PRN sequence which is a differential version of the original PRN sequence.

If PRN elements of the received signal are binary, then three values of P(k) elements are possible: −1, 0 or +1. In this case, values different from 0 correspond to fronts in the received signal.

If PRN elements are not binary, in particular, when the PRN sequence is an arithmetic sum of some binary PRN sequences or it is AltBOC-type PRN, for example, Galileo E5, the differential PRN sequence also does not have a binary form. Nonbinary PRN elements are multiplied by rectangular pulses, in the same way as for a binary version of PRN sequence.

In some embodiments, when receiving radio signals with known binary PRN sequence consisting of elements +1 and −1, the synthesized PRN sequence includes elements +1, −1 and 0, it is true for any element number k in the synthesized PRN and selected integer constant z: each element +1 in the synthesized PRN sequence with number k corresponds to value −1 in the element with number k+z of the known PRN sequence and value +1 in the element with number i+z+1 in the known PRN sequence; each element −1 in the synthesized PRN sequence with number k corresponds to value +1 in the element with number k+z of the known PRN sequence and value −1 in the element with number i+z+1 in the known PRN; and in the remaining cases, elements of the synthesized PRN sequence are equal to 0.

Non-zero constant z in the described implementations is selected to artificially shift the beginning of correlations by one pulse. When receiving signals without sub-carriers, this technique allows shifting to that part of the discriminator characteristic which possesses energy parameters that are worse than energy parameters for zero constant z, but does not have a vulnerable-to-multipath zone, this zone is shifted by one chip forward.

For another embodiment, when receiving signals with sub-carriers, P(k)=PRN(k).

In some embodiments, when receiving signals without sub-carriers, the bias of the expected moment of signal arrival is determined by quadrature I after summing six correlations and obtaining signal S. In another embodiment, it is determined according to quadrature Q.

In this case, when using quadrature I, the following nominal coefficients are selected: w₁=1, w₂=−1, w₃=−1, and when using quadrature Q: w₁=1, 0<w₂<1 and 0<w₃<1. In other embodiments, when using quadrature I, the following nominals of coefficients are selected: w₁=1, −1<w₂<0 and −1<w₃<0. In some embodiments, multiplication by coefficients w₂ and w₃ is implements by shifting the correlation result to the right. In some embodiments, multiplication by coefficients and summation of six correlations is produced in the process of calculating these correlations.

In a number of embodiments, when receiving a signal without subcarriers and when receiving a signal with subcarriers, the duration of the shortened pulse of the second correlation T₂ is chosen slightly less than the duration of the shortened pulse of the first correlation T₁. Moreover, in some implementations, the equation is satisfied:

T₁=T₂+T₃ (8)

For some embodiments the following expression is also satisfied:

$${T}_{3} ≪ t 30 - t 20 < \frac{T 0}{2} \qquad ( 9 )$$

The listed adjustable parameters make it possible to adapt the proposed method of specifying the moment of signal arrival, taking into account the following circumstances of the problem being solved: depending on the type of signal: without subcarriers or with two subcarriers; depending on the properties of the radio path and their influence on the discriminator characteristic; and depending on the application specific: satellite navigation signal or reflected radar signal.

The BOC signal is a signal with two subcarriers in satellite navigation. Signals of this type are characterized by significant subcarrier spacing. One often used definition of BOC is BOC (Fs/1023, Fc/1023), where Fs is the subcarrier frequency relative to the center frequency, and Fc=1/T0 is the chip rate, satellite navigation is characterized by Fs Fc. In contrast, the radar signal, taking into account the limitations of the radio path, can be implemented as BOC with Fs<Fc, and Fc can be several times greater than Fs.

Despite the significant range of BOC parameters and the fact that subcarriers may or may not be present, the method according to one embodiment obtains for the listed signals a discriminator characteristic corresponding to the properties stated above, and is implemented using a single parameterizable algorithm.

Let the discriminator characteristic be denoted as a function of S (Td), where S is one of the quadratures of the addition result for six correlations, and Td is a timing error calculated as true moment of signal arrival minus the estimated moment of signal arrival. According to the proposed method, the result S is related to Td as follows: it quickly increases proportionally to the timing error modulo at −T₁<Td<0; it rapidly decreases in proportion to the timing error when the positive timing error Td is close to zero, continues to decrease with an increase in the timing error to a value in the range T₁/2 . . . T₁, with a further increase in the timing error it increases to a negative value close to zero, but not equal to zero; with a further increase in the timing error, but not more than up to |t3−t0|−T₃/2, it keeps a negative value close to zero; it increases to zero with a further increase in the timing error Td to |t3−t0|+T₃/2; and it remains zero with a further increase in the timing error at least up to T0/2. FIG. 8 shows the five areas of function S(Td).

For the sake of clarity, similar sections of the S (Td) function for a signal with two subcarriers and a signal without subcarriers are shown by solid lines b01 and b02, sections specific for a signal with two subcarriers—by dotted lines b03 and b04, and the section specific for a signal without subcarriers—by dotted line b05.

In FIG. 8, the first area of the S (Td) function for −T₁<Td<0 corresponds to b06 in the case of a signal without subcarriers and at least to areas b06 and b11 in the case of a signal with subcarriers. The second area with rapidly decreasing S for 0<Td<T₁/2 . . . T₁ corresponds to the area b07. In this case, for a signal without subcarriers, the width of this section in one embodiment is equal to T₁, a S (T₁)=−h3, while for a signal with subcarriers, the width of this section is approximately equal to T₁/2, and S (T₁/2)≈−h2. The continuation of the second area with increasing S to a negative value −h1 that is close to zero, but not equal to zero, corresponds to section b08. In the case of receiving a signal without subcarriers, the width of this section in one embodiment is approximately equal to T₂, and in the case of receiving a signal with subcarriers, it is approximately equal to T₁/2. The third area of the function S (Td) for Td increasing from the boundary of the second area to t30−T₃/2 corresponds to the region b09. The fourth area of the S (Td) function for t30−T₃/2<Td<t30+T₃/2 corresponds to the section b10. The fifth area of the function S (Td) for Td from the boundary of the fourth region to at least T0/2 corresponds to the section b11. In one embodiment, h3 is roughly two times greater than h2.

The continuation of the section b03, not shown in FIG. 8, for a signal with two subcarriers in one embodiment retains a positive value, significantly greater than h1 up to Td=T0/2. At the same time, the discriminator characteristic for a signal without subcarriers at negative Td in most implementations asymmetrically repeats the discriminator characteristic at Td>0.

It should be noted that multipath mitigation when estimating the moment of signal arrival is determined by the shape of the discriminator characteristic S (Td) at positive Td. The closer to zero S with increasing Td, the less the influence of the signal copy delayed by Td. Since with the same slope of the S curve in the region of Td=0, the peak value of S at Td>0 for the case with two subcarriers is −h2, and for the case without subcarriers is −h3, and since h2<h3 (typical: h2≈h3/2), one can conclude that multipath suppression when receiving a signal with subcarriers will be better. At the same time, in the section b09, the proposed discriminator retains its sensitivity to the timing error value Td. At the same time, the multipath when the signal copy is delayed for a time from the b09 range affects the estimate of the reception time insignificantly, since h1 can be chosen significantly less than h2 or h3. In this case, the effect of multipath at Td>t30+T₃/2 completely disappears.

A better suppression of near multipath in the implementation corresponding to the discriminator characteristic with the b05 section is an advantage of working with a signal formed on two subcarriers. At the same time, when receiving a signal without subcarriers, the function F (t), as already noted, turns into a constant independent of t, which makes possible, when receiving such a signal, not to perform additional calculations associated with the implementation of multiplication by the function F (t), which is the advantage of receiving a signal on a single carrier.

Parameters h3, h2, h1, t30, T₃ and some others can be changed in a wide range, which allows achieving optimal results for different types of signal, characteristics of the radio path and different conditions of the problem being solved. In particular, the parameter h1 is increased or decreased by increasing or decreasing T₃ and the coefficient w₃. In a number of implementations, the parameters h1 and t30 are chosen in such a way that in the section b09 the ripple of the discriminator characteristic due to the influence of the radio part does not lead to a dangerous approach of the discriminator characteristic to the zero line, and even more so to its crossing. In this case, in a number of implementations, the value of the section b09 or the value of t30 is determined so that it guarantees |S (Td|>h1 for the following Td: in the case of receiving satellite signals, for all Td corresponding to the range of possible error when DLL tracking in range; and in the case of receiving reflected radar signals, for all Td corresponding to the range of possible tracking error in range, taking into account possible primary artificial shift of Td to the positive side.

The indicated artificial shift of Td to the positive direction is explained by the fact that in one embodiment the input into the system of signal tracking from each detected reflecting object is performed as follows: in a given direction, one emits and receives a signal with a known PRN sequence of T0-duration pulses, calculates the correlation characteristic of the received signal with the emitted one, the calculated correlation characteristic being a multitude of results for the predicted moments of signal arrival t0 with a step Tr, with Tr≤T0/2; for each t0, at which the correlation characteristic is higher than a given threshold, one begins tracking this reflected signal using the proposed method, the estimated time of signal arrival t0 being artificially shifted towards the earlier arrival of the signal by the value Tdinit, and Tdinit<t30<Tr; and the moment of signal arrival is gradually specified, as a result of which the timing error Td becomes close to zero.

The addition of the artificial timing error Tdinit to the initial estimate of t0 provides a better multipath mitigation in the case when the power of the reflected signal from more distant objects exceeds the power of the reflected signal from the nearest object. It can be explained by the fact that in the presence of delayed copies of a high-power signal, it is difficult to specify the arrival time of the earliest signal at an initially negative Td. At the same time, due to the properties of the discriminator characteristic in the region of positive Td, with a gradual improvement of Td in the direction of its decrease, the influence of powerful delayed signal copies can be minimized.

Since the addition of six correlations proposed in this method is a linear operation, the selection of parameters for summing, and parameters of correlations themselves can be easily done based on correlation characteristics of the sum of first correlations S₁=S_{1,1}+S_{2,1}, second correlations S₂=S_{1,2}+S_{2,2}, and third correlations S₃=S_{1,3}+S_{2,3} of each group. It is clear that S(Td)=S₁(Td)+S₂(Td)+S₃(Td). Along with parameters, the form of each of these functions strongly depends on the type of received signals.

An example of function S₃(Td) multiplied by coefficient w₃ is illustrated in FIG. 9. The dotted line c01 corresponds to multiplication S₃(Td)*w₃ for some embodiments when receiving signals without subcarriers, and c02—when receiving signals with two subcarriers.

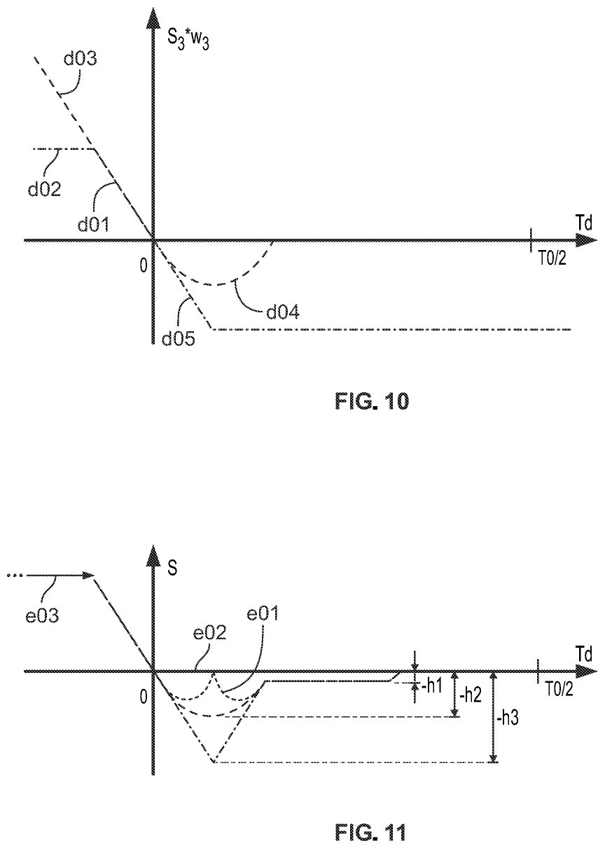

An example of function S₁(Td) multiplied by coefficient w1 is illustrated in FIG. 10. Similarly to FIG. 8, in FIG. 10, the solid line d01 corresponds to the product S₁(Td)*w₁ that is the same for both types of signal, the dashed lines d02 and d05 correspond to the product S₁(Td)*w₁ for some implementations when receiving a signal without subcarriers, and d03 and d04—when receiving a signal with two subcarriers

It is clear that multiplication product S₂(Td)*w₂ is the difference between graphs shown in FIGS. 8, 9 and 10.

It should be noted that, in some embodiments, the S (Td) dependence in section b09 of FIG. 8, when receiving a signal with two subcarriers, has insignificant variations relative to the level −h1.

In some embodiments, the value of T₁ is selected based on the bandwidth of the radio part, the ratio T₃/T₁ is based on the ripple of the amplitude-frequency response and phase-frequency response in the bandwidth of the radio part, the difference |t3−t1|—based on the dynamic characteristics of the receiver, surrounding objects and the properties of the tracking system.

The BOC signal at certain ratios of frequencies Fs and Fc can be considered not only as a signal with subcarriers, but also as a signal without subcarriers with a higher chip rate and it can be accordingly received and specified in terms of the signal arrival time.

Taking into account the above, two embodiments of the proposed method can be distinguished, as well as a third combined embodiment for BOC type signals.

For one embodiment that is typical for receiving signals generated as a single carrier signal, function signₜ(g) returns +1 or −1 depending on the group number g, elements P(k) are calculated according to formula (7), coefficients w₂ and w₃ are −1, and quadrature I is used in the total sum S. Function F_{g}(t) at formal subcarrier frequency equal to zero does not depend on t, and can be replaced by a constant in some embodiments.

For the given embodiment, asymmetrical dependence S(Td) with the following properties is typical:

sign(S(Td))=−sign(Td) at |Td|<T0/2

S(Td)˜−Td at |Td|<T₁

S(Td)≈−T₃/T₁*S(T₁*sign(Td)) at 2*T₁<|Td|<|t30|−T1/2

S(Td)≈0 at |t30|+T₁/2<|Td|<T0/2

In another embodiment, typical for receiving signals with two sub-carriers, function signt(g) returns the same value irrespective of the group number g, P(k)=PRN(k), coefficients w₂ and w₃ are equal to unit divided by the integer degree of number 2.

In some embodiments, when receiving signals with subcarriers or without subcarriers, the multiplication by F_{g}(t) is produced simultaneously with moving the signal to zero frequency.

For this embodiment, asymmetrical dependence S(Td) with the following properties is typical:

sign(S(Td))=−sign(Td) at |Td|<T0/2

S(Td)˜−Td at 0<−Td<T₁

S(T₁/2)≈−S(−T₂/2)/2

|S(Td1)/Td1|>S(Td2)/Td2| at 0<Td1<Td2<T₁

In this embodiment, when receiving a BOC signal with certain ratios of frequencies Fs and Fc, and as a consequence, having simultaneously, the properties of both a signal formed on one carrier and a signal formed on two subcarriers, this signal can be received both according to the implementation designed for receiving a signal on single carrier and according to the implementation designed for receiving a signal with two subcarriers.

In some embodiments, the BOC signal is partially received in accordance with an implementation for receiving a signal on one carrier, and then in accordance with an implementation for receiving a signal with two subcarriers. For example, if the near multipath is insignificant, then the implementation of the proposed method corresponding to a single carrier signal is used. In this case, in some embodiments, the part of the hardware associated with the computations required only for the embodiment with two subcarriers is turned off. If the near multipath is significant, the BOC signal is received in accordance with the implementation for a signal with two subcarriers. In this case, in some embodiments, it is possible to switch between receiving the BOC signal as a signal on one carrier and receiving the BOC signal as a signal on two carriers. This switching can be performed repeatedly depending on changes in the properties of the received signal.

In some other embodiments the BOC signal may be received simultaneously both as a signal with a single carrier and a signal with two subcarriers. The need for simultaneous reception in both ways may be associated with the inability to instantly switch between one and the other method of one device without losing synchronization.

In some embodiments, simultaneous reception of the BOC signal in both ways when strong multipath is present can be carried out permanently. This is explained, first, by the fact that in some transmitters, for example, in the transmitter of the satellite navigation signal, the method of forming the BOC signal is implemented as forming a signal with a single carrier, and as a consequence, the fronts of the chips, when viewed on a single carrier, have a more accurate and rapid shape than the fronts of the chips, when viewed on two subcarriers. Due to this, the reception of the BOC signal as a signal on one carrier and simultaneously as a signal on two subcarriers after combining the results can partially compensate for systematic errors in the timing estimation obtained separately in each of the implementations. Second, the difference in discriminator characteristics indicated in FIG. 8 in sections b07 and b08 for different implementations of the proposed method allows one to assess the effect of multipath on the result and partially compensate for it.

For example, if a copy of the received signal delayed by b07 resulted in an error in estimating the time of arrival of the signal t0 in one implementation by E_{A} proportional to h3, and in another implementation by E_{B} proportional to h2, then after subtracting from the second result the difference between the first and the second results, the residual error E_{comb} in some DLL implementations will be determined by the following formulas:

t0=t0_{A}−E_{A}=t0_{B}−E_{B} (10)

t0_{comb}=t0_{B}−(t0_{A}−t0_{B})=t0−(E_{A}−2*E_{B})=t0−E_{comb} (11)

using E_{A}/E_{B}=h3/h2 to obtain:

$${E}_{comb} = {E}_{A} - 2 * {E}_{B} = {E}_{A} * ( 1 - \frac{2 * h 2}{h 3} ) = {E}_{B} * ( \frac{h 3}{h 2} - 2 ) \qquad ( 12 )$$

Considering approximate parity h3≈2*h2, both differences in braces of formula (12) are close to zero, which makes the error in the estimated timing considerably less than separately obtained errors in each embodiment before their combination.

With other signal copy delays, the positive effect of combining the results in accordance with formula (11) will be less, but the error itself in these cases will be less. In this case, for any delay of the signal copy, the error after combining the results does not turn out to be greater in absolute value than the original errors.

It should be noted that the given above formulas were obtained when combining the results of two implementations of the proposed method in accordance with the following formula:

S_{comb}=S_{B}−C_{AB}*(C_{A}*S_{A}−S_{B}) (13)

where
S_{A} is the addition result for six correlations when receiving signal as signal without subcarriers;
S_{B} is the addition result for six correlations when receiving signal as signal with two subcarriers; and
C_{AB} and C_{A} are the coefficients, and C_{AB} is normally smaller or equal to unit.

Parameter T₁ in convolutions inputted in result S_{A} is made equal to half of the same parameter T₁ in convolutions of result S_{B}.

Combined discriminator characteristic for the given embodiment of the method, for which the obtained result corresponds to formula (13) at C_{AB}=C_{A}=1, is shown in FIG. 11.

The main change in the discriminator characteristic after calculating formula (13) corresponds to the dashed section of the e01 curve shown in the figure. The maximum of this section e02 corresponds to Td=T₁ in the S_{A} result and T₁/2 in the S_{B} result. This implementation should not be used at large negative timing errors, shown in the figure as the e03 range.

In some embodiments, the coefficient C_{AB}<1 is used, which, in particular, makes it possible to lower the level of the point e02 to the level −h1.

In some embodiments, the timing error of the estimated time of arrival of the BOC signal is determined by combining the results obtained by correlating the BOC signal as a signal with a single carrier and the results obtained by correlating the BOC signal as a signal on two subcarriers, using a formula different from formula (13).

In some embodiments, the S_{A} and S_{B} results are computed alternately in a time-division mode to reduce power consumption.

In a number of embodiments, when receiving a BOC signal as a signal with two subcarriers, T₁ is selected twice as much as when receiving a BOC signal as a signal on a single carrier. This is due to the fact that when the BOC signal is received as a signal formed on a single carrier, the first correlations together form a doubled short pulse, capturing twice the signal portion than the joint pulse of the first correlations when it is received as a signal with two subcarriers. In this case, the pulse duration in the first correlation (doubled when receiving a signal formed on single carrier, and single for a signal with two subcarriers) determines the width of the discriminator's increased sensitivity to near multipath. The natural desire to reduce, in a number of embodiments, the pulse duration in the first correlations to a minimum is restricted by the limited band of the radio part, due to which an excessive reduction in the pulse duration becomes ineffective.

It should be noted that the correlation of the input signal with PRN sequence of the shortened pulses is equivalent to including only a certain portion of the input signal in the correlation. Moreover, when the two-subcarriers-signal is correlated, each correlation contains a part of the signal energy corresponding not only to certain time intervals, but also to one of the two subcarriers.

The sum of the first correlations S₁=S_{1,1}+S_{2,1}, second correlations S₂=S_{1,2}+S_{2,2} and third correlations S₃=S_{1,3}+S_{2,3} from the first and second groups are calculated in some embodiments as follows: correlations of the first and second groups are separately calculated first, then the obtained results are added. In some other embodiments, each of the three sums (S₁, S₂, S₃) is calculated at once as pair (doubled) correlation, this makes such an implementation a little simpler.

In some implementations, the received signal with at least two subcarriers, in particular the BOC signal, is generated as the multiplication product of the known PRN sequence of the rectangular pulses by the modulating signal. In this case, the modulating signal determines the number of subcarriers and their properties. For example, in the BOC (1,1) signal, such a signal is a meander with frequency of 1.023 MHz. This signal forms paired subcarriers, with the greatest energy concentrated on subcarriers located at 1.023 MHz from the center frequency. Portions of the signal falling on different subcarriers can be simultaneously included in the doubled (or, which is the same, total) correlation, taking into account the signs of the coefficients, by which the results of the correlations of each group are multiplied according to formula (6). Taking into account different implementations of sign_{w} (g), the obtained implementations of calculating pairwise correlations are also different.

In a number of embodiments, when calculating pair correlations of signals of this type, the received signal is correlated with the known PRN sequence of rectangular pulses multiplied by the Hilbert transform of the modulating signal. In this case, after receiving the signal S, the timing error value of the estimated moment of signal arrival is determined by the quadrature I, and not by the quadrature Q. In some implementations, the Hilbert transform of the modulating signal can be calculated approximately. In some implementations, when receiving a sine-type BOC signal, the Hilbert transform of the modulating signal is equivalent or close in implementation to transform of BOC sin to BOC cos.

In some embodiments, calculations according to formula (6) are close to the Hilbert transform of modulated signal with scale factor 2. In a number of other embodiments, the scale is not applied.

In the embodiments of signal reception with at least one paired subcarrier, portions of the signal from the first half of the pulse are used in correlations, with the results of each pair correlation being added with the same signs, and the total result of the first pair correlation being added with a larger weight.

In some embodiments, the refinement of the time arrival of a signal generated on a single carrier is calculated by formula (6), grouping the calculations into three paired correlations. As a result, as in the case of signal reception with subcarriers, the results S₁, S₂, S₃, are calculated and then these results are added according to the formula.

In some embodiments, the addition of six correlations or three paired correlations is performed simultaneously with the calculation of the correlation results.

It should be noted that in each of the three paired correlations (S₁, S₂, S₃), two equal energy portions of the received signal pulse are used, which are either a) symmetrically ahead and late relative to the pulse boundary, or b) focused on subcarriers symmetrically spaced from the center frequency and are the same time fragment within the pulse. In this case, the indicated two portions of the signal or the results of correlations with the participation of these portions are added. In this case, in a number of embodiments, case “a)” corresponds to the refinement of the moment of arrival of the signal formed as a signal on one carrier, and case “b)” corresponds to the refinement of the arrival moment of the signal formed as a signal with at least one paired subcarrier.

In this case, the combination of two correlations into one pair correlation using the Hilbert transform of the modulating signal assumes that the specified Hilbert transform is the sum of the Hilbert transform of the modulating signal for positive subcarriers and the Hilbert transform of the modulating signal for negative subcarriers.

In some embodiments, the modulating signal generating the positive subcarriers is different from the signal generating the negative subcarriers. In addition, in a number of implementations, when generating positive subcarriers, one known PRN sequence is used, and when forming negative subcarriers, another known PRN sequence is used. An example of such a signal is AltBOC. The time of arrival of such signals in a number of embodiments is specified as the sum of the results S according to formula (6), where each result is calculated separately for one and the other known PRN sequences, and then added. Moreover, in a number of implementations, the results of six correlations, including their sums (S₁, S₂, S₃), are not calculated as pair correlations.

In a number of embodiments, the results of three correlations from the first group are multiplied by one additional complex coefficient, and the results of three correlations from the second group are multiplied by another coefficient. These coefficients can be used to equalize the radio path or for more accurate beamforming in a Multiple Input, Multiple Output (MIMO) antenna. In these implementations, the correlations of the first and second groups are calculated separately, then the results obtained are multiplied by additional coefficients, then added in pairs, obtaining the sums S₁, S₂, S₃, and then, taking into account the coefficients, the total result S is obtained in accordance with formula (6).

In some embodiments, when receiving portions of the signal that are not involved in any correlation, some calculations, such as move to zero frequency and multiplication by subcarriers, may not be performed. According to formula (5), such moments in time occur when, in calculating all correlations, the rect ( ) function returns zero, or when the element P(k) is equal to zero.

In some other embodiments, the portion of the signal involved in the correlation is determined only by the properties of the rect( ) and F( ) functions. In this case, the function rect( ), as follows from formula (5), depends only on time, and the function F ( )—only on the subcarrier index. As a consequence, the signal portion used in each of the correlations is periodic in time and, in some implementations, is frequency selective. Accordingly, a portion of a signal in these embodiments means a portion of a signal in each rectangular pulse of the received signal with a repetition period of the boundaries of these portions equal to T. In embodiments with different results F( ) for the first and second group of correlations, or, which is similar, with different results F ( ) in the pair correlation components, these portions also determine the subcarrier used in this correlation or pair correlation component.

The result S in some such implementations is equal to the sum of the correlations of six portions of the received signal, calculated in the form of three pair correlations, where each portion corresponds to the use of a certain part of the energy of rectangular pulses in each of the correlations and the non-use of the signal in this pair correlation for the rest of the time, and in the third pair correlation uses short portions of the signal far from the pulse boundary, the first pair correlation uses the signal portions adjacent to the pulse boundary, and the second pair correlation uses the second portion of the signal between the portions of the signal used in the first and third pair correlation, while the second portion of the signal within the pulse is adjacent to the first portion and is at a considerable gap from the third portion.

Some of these implementations are similar to the embodiments described above, which calculate the result S in the form of three pairs of correlations or in the form of six separate correlations.

In accordance with an embodiment, the following actions should be taken: at least one Prompt correlation of the signal with known PRN sequence of shortened or non-shortened rectangular pulses moved to zero frequency is calculated, the carrier phase of the received signal in moving to zero being selected such that Prompt modulo of component I would be maximal, and component Q modulo—minimal; a result of dividing the selected quadrature of the result S by quadrature I of the result Prompt is calculated; a timing error estimate for the expected moment of signal arrival is determined according to the calculated division result.

In some embodiments, Prompt correlation is calculated as a response to the input signal of the matched filter. The correlation characteristic Prompt(Td), where Td (as it was in the above described correlations) corresponds to the timing error of the expected moment of signal arrival, is close to the autocorrelation characteristic of the input signal.

In a number of embodiments, when receiving a navigation satellite signal, a set of correlation results with a step Tr, the result S and the result of Prompt for the selected t0 are calculated for each line-of-sight satellite signal.

In a number of other embodiments, when receiving reflected radar signals, a multitude of correlation results with a step Tr, the result S, and the result of Prompt for the selected t0 are calculated for each distinguishable reflected signal from the surrounding objects. Moreover, in a number of embodiments, the transmitting and receiving radar antennas contain more than one antenna element, each of which is connected to a separate DAC or ADC, thus forming a MIMO system.

In a number of embodiments with a MIMO-type antenna system the following actions are additionally taken: a signal from each ADC is correlated according to the proposed method and the above described correlation characteristic is obtained for multitude of different t0, as well as results S and Prompt; each of said results is multiplied by a complex coefficient in accordance with the directional pattern formed by MIMO system, then the results are added and summed results are obtained; and exceeding of a threshold and a timing error estimate of the expected moment of signal arrival are determined based on the calculated sums.

In a number of embodiments, the satellite signal is received using several antennas, with the signal from each antenna being processed in accordance with the proposed method.

Thus, in a number of embodiments, a set of the described correlation results for different signals is calculated, these results are either combined in the future to form total results, or are processed independently, since they contain information independent of each other.

In a number of embodiments, the specified moment of arrival of the navigation signal from different satellites or local transmitters is then used as raw data to solve the navigation task t, the result of which is the determination of navigation receiver's position and velocity, as well as the time information included in the satellite or locally transmitted signals.

In a number of other embodiments, the specified moment of arrival of the reflected radar signal from different objects is then used as input data for constructing a three-dimensional image of the surrounding space, determining the direction to the closest and most important obstacles, determining the distance to these obstacles.

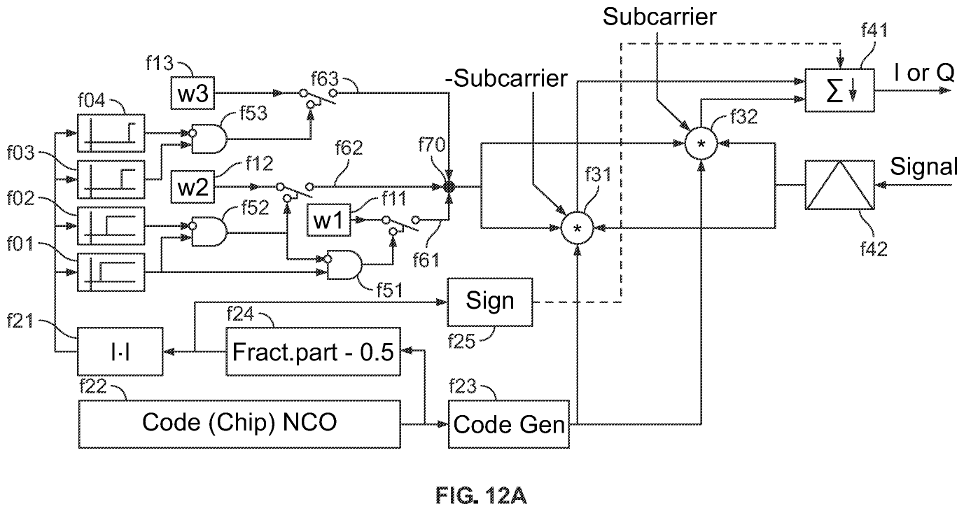

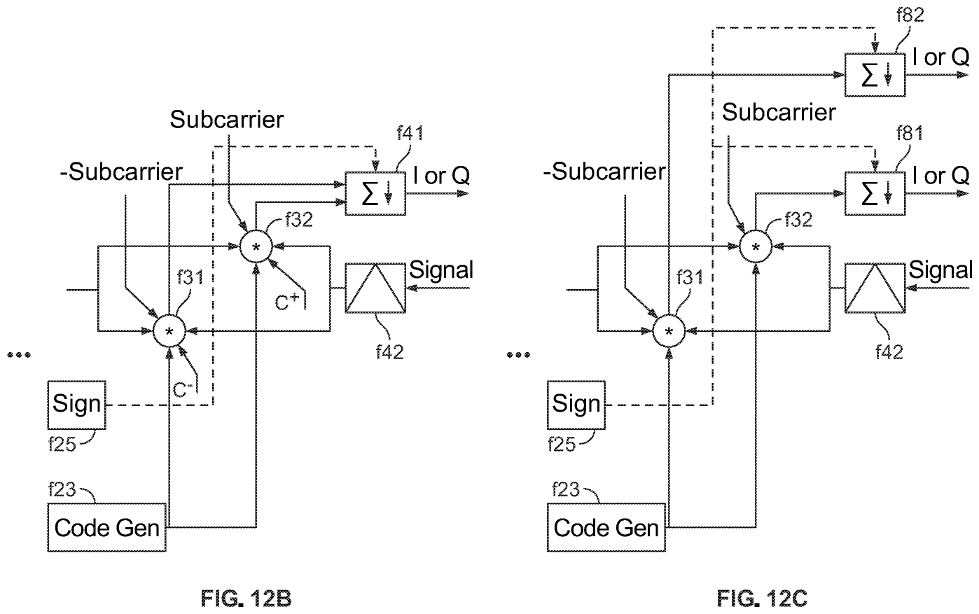

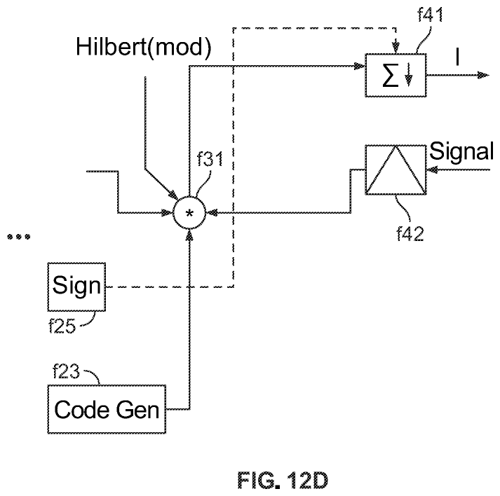

The proposed method can be implemented as an apparatus (with various embodiments shown in FIGS. 12A-12D) with a correlator comprising: a mixer f42 to the input of which the received signal is fed, and at its output there are formed two quadrature signals; three memory elements f11, f12, f13 storing three coefficients; a comparison unit with four time thresholds f01-f04 and four states at the output, wherein at the output there is generated a first state, if the input value is less than threshold 1, or at the output there is generated a second state, if the input value is less than threshold 2, or at the output there is generated a third state, if the input value is between thresholds 3 and 4, otherwise, zero state is generated at the output; a commutation unit implemented in some embodiments as gates “AND” f51, f52, f53 and a set of switches selecting at its output f70 one of the three coefficients or zero depending on the state at the output of the comparison unit; an Numerically Controlled Oscillator (NCO) f22 counting integer and fractional part of the chip number in the epoch; a fractional extraction module f24 taking the fractional part of the chip number and subtracting 0.5 from it, thereby counting time after the front during the first half of the chip from 0 up to +0.5, and during the second chip half from −0.5 up to 0; a unit to calculate modulo of the signed number f21; a code generator f23; a first multiplier f32 calculating the multiplication product of a code generator's output signal, a mixer's output signal, and a commutation unit's output signal; and an accumulator of results for one quadrature being chosen, it is the output of the correlator.

The output of the first multiplier is added in the accumulator, NCO output is connected to the code generator and to the input of the fractional extraction module, the output of the fractional extraction module is connected to the unit of modulo computation, and its output is fed to the input of the comparison unit.

In the proposed apparatus, the mixer moves the received signal to the zero frequency or to the frequency of one of subcarriers, the code generator generates a sequence of numbers corresponding the synthesized PRN sequence described above, NCO forms a time scale in the form of an incremented counter, the high-order bits of which contain the integer part of the chip number k in the current epoch (with 1≤k≤N), and the lower-order bits contain the fractional part of the chip.

In some embodiments, the first, second, third and zero states at the output of the comparison unit are implemented using three binary signals, while the state 1 . . . 3 at the output of the comparison unit is realized in the form of an active state of the corresponding signal and an inactive state of the remaining signals, and the zero state is inactive state of all three signals. In this case, the switching device selects one of three coefficients according to the number of the active output of the comparison device, or 0, if all signals are inactive.

To implement the proposed method for specifying the moment of arrival of a signal without subcarriers, one correlator with the described structure is sufficient. For a signal with two subcarriers, in some implementations, two such correlators are required. That is why in a number of embodiments a correlator additionally includes: a mechanism of sign selection f25, at the input of which the output of the fractional extraction module is supplied, with the negative value at the input, the mechanism outputting 1, otherwise −0; and a second multiplier f31, which calculates the product of the mixer output, the output of the commutation unit and the output of the code generator. In this case, in the first multiplier, the calculated product is additionally multiplied by the subcarrier with a positive sign, and in the second multiplier, by the subcarrier with a negative sign. The output of the sign selection mechanism is connected to the control input of the accumulator, and the output of the second multiplier is fed to the second (subtractive) input of the accumulator.

If there is zero on it and when the corresponding mode is turned on, the control input of the accumulator blocks the addition of new values to the sum.

In some embodiments, the first or second multiplier is part of the mixer.

In some embodiments, the output of the sign selection unit is the most significant bit (also referred to as MSB) of the input number. With this embodiment, the most significant bit from the output of the fractional extraction module is supplied to the control input of the accumulator

One embodiment of the proposed apparatus is illustrated in FIG. 12A. In FIG. 12A, a comparison unit with four threshold devices f01, f02, f03 and f04 and three gates “AND” f51, f52 and f53 generates three output signals that close either switch f61, or switch f62, or switch f63, or none of them. These switches, when on, pass one of coefficient values w1, w2, or w3, from one of respective memory elements f11, or f12, or f13 to the output. Otherwise, zero is formed at point f70. The listed elements jointly implement a comparison unit and a communication unit for three coefficients. In this case, the multipliers f31 and f32 calculate the product of the output of the mixer f42, the code generator f23, the value at point f70 and, optionally, one of the subcarriers. In this case, the NCO output is fed to the code generator using the integer part of the result, and to the thresholds f01, f02, f03, f04 through the fraction extraction module f23 and taking the f21 module. The most significant bit (MSB) of the NCO output is also fed to the control input of the adder f41.

In some embodiments, multiplication by one of the subcarriers in either f31 or f32 is not performed. In this case, in the mixer, the signal is multiplied not by the center frequency, but by the frequency of the subcarrier, while in the other multiplier the product is calculated with a doubled subcarrier rather than with another subcarrier.

In some embodiments, when calculating the product, the first multiplier also multiplies by the first additional complex coefficient, and the second multiplier multiplies by the second additional coefficient. The corresponding fragment of the proposed apparatus with additional complex coefficients C− and C+ is shown in FIG. 12B.

In some other embodiments, multiplication by additional complex coefficients in the first and second multipliers is not performed. Instead, in these embodiments, the product of one of the multipliers is fed to the input of the second accumulator. In this case, the output of the sign selection mechanism is fed to the control input of the second accumulator and to the control input of the first accumulator. The functionality of the second accumulator is similar to the functionality of the first accumulator. This means that both accumulators, when a certain mode is turned on, add the result of the multiplier product if the value 1 is present at the control input, otherwise the addition is not performed. The corresponding fragment of the proposed device with two accumulators f81 and f82 is shown in FIG. 12C.

In a number of other embodiments, in the first multiplier, the product of the mixer output, the commutation unit output and the code generator output is calculated, and these values are also multiplied by a signal being equivalent to or related to Hilbert transform from the signal used to form the subcarriers of the received signal. The corresponding fragment of the proposed device is illustrated in FIG. 12D.

In some embodiments, the proposed device contains several correlators of the described type. In some embodiments, some of the correlators contain multiplication by at least one subcarrier or by the Hilbert transform from the modulating signal, and the other part of the correlators does not contain such multiplication.

In a number of embodiments, in addition to correlators with the described structure, there are correlators of another type intended for calculating Prompt result. In some such implementations, the Prompt result is calculated by the correlator in the form of a matched filter with the input signal and the correlation characteristic Prompt vs. Td close to the autocorrelation characteristic of the input signal. Thus, these device embodiments contain several types of correlators. Correlators of the first type are designed to specify the moment of signal arrival. These correlators are implemented in accordance with the structure described above. Correlators of the second type are not intended for estimating the moment of signal arrival. However, in some embodiments, the results obtained at the output of correlators of the second type can also be used to refine the moment of signal arrival.

In some devices, correlators of the first type and correlators calculating Prompt are implemented as a single structure. At the same time, additions are made to the correlator implementation scheme described above to specify the moment of signal arrival, allowing one to simultaneously calculate both the result to specify the moment of signal arrival and the Prompt result.

In some embodiments, the proposed device contains a processor. In this case, in each correlator, the accumulator of the result intended to specify the moment of signal arrival, and the control input NCO of this correlator are connected to the processor.

In some embodiments, the device also contains an antenna input connected to the mixer input of each correlator.

The foregoing Detailed Description is to be understood as is in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method of specifying an arrival time of a radio signal having a shape similar to a known pseudo random noise (PRN) sequence of rectangular pulses moved on a radio frequency, the method comprising:
generating two quadrature signals also referred to as moved-to-zero frequency signal by multiplying the signal by a carrier;
synthesizing a PRN sequence of shortened pulses related to the known PRN sequence;
calculating six correlation results of the moved-to-zero frequency signal with the synthesized PRN sequence;
multiplying each of the six correlations results by a correlation coefficient;
summing the multiplied correlation results for one of the two quadrature signals;
estimating a timing error that is an error of signal arrival time relative to a predicted arrival time based on the result obtained from summing the multiplied correlation results for one of the two quadrature signals; and
generating an improved signal arrival time by adding the estimated timing error to the predicted signal arrival time,
wherein the six correlations and respective six beginning time moments related to them form two groups of three correlations, the two groups of three correlations having one of the boundaries of the shortened pulses of a first correlation in each of two groups matching one of boundaries of the pulses in a received signal,
a second boundary of shortened pulses of the first correlation coinciding with one of shortened pulse boundaries of the second correlation, the time interval between neighboring boundaries of shortened pulses of the second and third correlations, as well as the time interval between neighboring boundaries of shortened pulses of the first and third correlations being longer than the duration of the shortened pulses of the third correlation,
a difference between beginning time moments of first, second, and third correlations of the first group and the predicted arrival time by modulo is equal to the difference between the predicted arrival time and beginning time of the first, second, and third correlations of the second group and the absolute values of a first, second, and third coefficients by which the first, second and third correlations from the second group are multiplied when adding being the same as the absolute values of the first, second and third coefficients by which the first, second, and third correlations from the second group are multiplied, but signs of the coefficients by which correlations from the first group are multiplied being either the same as the signs of all the three coefficients by which the correlations from the second group are multiplied, or opposite to the signs of coefficients by which the correlations from the second group are multiplied.

2. The method of claim 1, wherein shortened pulses of first, second, and third correlations of each groups are not overlapped, and all shortened pulses with a given number from first, second, and third correlations of each group are entirely to one side from a predicted boundary between any neighboring pulses in the received signal, as well as to one side from a predicted midpoint of each pulse of the received signal.

3. The method of claim 2, wherein in each group beginning moments of first, second and third correlation t1, t2, t3 are related to the midpoints of the shortened pulses of first, second, and third correlations with pulse durations T₁, T₂ and T₃, respectively, and a predicted time of beginning signal arrival t0 is associated with the beginning of pulses of the received signal with duration T0, at this the result S of adding six correlations being related to the timing error Td calculated as a moment of signal arrival minus the predicted time of signal arrival is as follows:
S quickly increases in proportion with the modulo of the timing error at T−T₁≤Td≤0;
S quickly decreases proportionally to increasing of the timing error when the timing error Td is positive and close to zero;
S continues to decrease when the timing error further increases up to the value within a range T₁/2 . . . T₁, and when the timing error keeps increasing beyond T₁, S increases up to a negative value close, but not equal to zero;
when the timing error increases further, but no more than up to |t3−t0|−T₃/2, S retains a negative value close to zero;
when the timing error increases further up to |t3−t0|+T₃/2, S increases; and
when the timing error increases further at least up to T0/2, S remains zero.

4. The method of claim 3, wherein the difference between initial moments of time t1, t2, t3 of the first, second, third correlations of the first group and a predicted moment of the radio signal arrival t0 is opposite in sign of the difference between the initial moments of the first, second, third correlation of the second group and the predicted moment of signal arrival, at this, the synthesized PRN sequence is calculated by differentiating the known PRN sequence, and when adding the results of six correlations, the result of the first correlation from each group being multiplied by a coefficient of +1, and the results of the second and third correlations being multiplied by a coefficient of −1.

5. The method of claim 4, wherein result S of adding the six correlations is calculated for quadrature I.

6. The method of claim 5, wherein the result S is related to the timing error Td of a predicted arrival time of the radio signal as follows:
S(Td)˜−Td at |Td|<T₁
S(Td)≈−T₃/T₁*S(T₁*sign(Td)) at 2*T₁<|Td|<|t3−t0|−T₁/2
S(Td)≈0 at |t3−t0|+T₁/2<|Td|<T0/2.

7. The method of claim 6, wherein the value of T₁ is selected based on the bandwidth of the radio path, a ratio T₃/T₁ is based on a ripple of a gain to frequency response and delay response in the bandwidth of the radio path, the difference |t3−t1| is based on receiver's dynamic characteristics, surrounding objects and properties of a tracking system.

8. The method of claim 7, wherein the received signal is a satellite signal transmitted by a GNSS system.

9. The method of claim 3, wherein beginning times t1, t2, t3 of the first, second, third correlations of the first group are equal to initial times t1, t2, t3 of the correlations of the second group, with the synthesized PRN sequence being considered equal to the known PRN multiplied by the subcarrier with one sign when calculating three correlations of the first group frequency, and when calculating three correlations of the second group to a subcarrier with a different sign of the frequency, while the initial phase of the subcarriers is the same constant.

10. The method of claim 9, wherein the coefficients by which the first, second and third correlations from the first group are multiplied are opposite in sign to corresponding coefficients for the second group.

11. The method of claim 10, wherein result S of adding six correlations is calculated for quadrature signal Q.

12. The method of claim 11, wherein the result S is related to the timing error Td of the predicted arrival time of the radio signal as follows:
sign(S(Td))=−sign(Td)
S(Td)˜−Td at T1>Td>0
S(T1/2)≈−S(−T1/2)/2

|S(Td1)/Td1|>|S(Td2)/Td2| at 0<Td1<Td2<T1.

13. The method of claim 12, wherein a modulus of the coefficient multiplied by the result of the first correlation is +1, the moduli of the coefficients multiplied by the result of the second and third correlations are less than one and are equal to one divided by an integer power of 2.

14. The method of claim 13, wherein the received signal is a reflected radar signal with two subcarriers.

15. The method of claim 13, wherein the received signal is a satellite BOC signal of one of a plurality of GNSS systems.

16. The method of claim 3, wherein the following settings are applied when receiving BOC-type signal having properties of both one carrier-generated signal and two subcarriers-generated signal
a) during some part of time T_{A}:
differences t1−t0, t2−t0, t3−t0 for the first, second, third correlations of the first group are opposite in sign to differences t1−t0, t2−t0, t3−t0 for the first, second, third correlations of the second group;
the synthesized PRN sequence is calculated by differentiating the known PRN sequence;
when adding the results of six correlations, the result of the first correlation from each group is multiplied by a factor of +1, and the results of the second and third correlations are multiplied by a factor of −1; and
the result SA of the addition of six correlations is calculated for the quadrature I, and
b) during some part of time T_{B}:
the beginning time moments t1, t2, t3 of the first, second and third correlations of the first group are equal to the beginning time moments t1, t2, t3 of correlations of the second group;
the synthesized PRN sequence is considered equal to the known PRN sequence, multiplied when calculating three correlations of the first group by a subcarrier with one frequency sign, and when calculating three correlations of the second group by a subcarrier with a different frequency sign;
the modulus of the coefficient multiplied by the result of the first correlation is +1, the moduli of the coefficients multiplied by the result of the second and third correlations are less than one and are equal to one divided by an integer power of 2, while the signs of the three coefficients multiplied by the results of correlations of the first group are unequal to the signs of three coefficients multiplied by the results of correlations of the second group; and
the result S_{B} of adding six correlations is calculated for quadrature Q.

17. The method of claim 16, wherein the timing error of the predicted arrival time of the BOC signal is determined by combining the results obtained during time intervals T_{A} and T_{B}.

18. The method of claim 17, wherein time intervals T_{A} and T_{B} are overlapped.

19. The method of claim 18, wherein at least some parameters from t1, t2, t3, T₁, T₂, T₃ used in correlations when calculated result S_{A} are not equal to the same parameters used in correlations when calculating result S_{B}.

20. The method of claim 19, wherein the results S_{A} and S_{B} are combined into final result S_{comb} according to formula S_{comb}=S_{B}−C_{AB}*(C_{A}*S_{A}−S_{B}), where C_{AB} and C_{A} are coefficients, with C_{AB}≤1.

21. A method for specifying an arrival moment of a radio signal with a known PRN sequence of rectangular pulses into a navigation receiver or radar, the method comprising:
determining a timing error of an estimated moment of signal arrival by a sum of correlations of six portions of the received signal, calculated as three pairs of correlations, where each portion corresponds to the use in each of the six correlations of a part of the energy of rectangular pulses and the non-use of the signal in this correlation for the remaining time, and, in a third pair of correlations, each correlation uses a short pulse fragment far from the pulse border, in a first pair of correlations, each correlation uses a first long pulse fragment adjacent to the border of the pulse, and in a second pair of correlations, a second long fragment of the pulse between the fragments of the pulse used in the correlations of the first and third pairs, while the second long fragment of the pulse is adjacent to the first long fragment and is at a distance from the short fragment of pulse;
when receiving a signal formed as a single carrier signal, the received signal is correlated with a differentiated version of the known PRN sequence, when in the first correlations from each pair, portions of the signal from the first half of the pulse are used, in the second correlations from each pair, fragments of the signal from the second half of the previous pulse are used, and when correlations in each pair are summed with those of the same signs, the total result of the second and third pairs is added with one sign, and the total result of the first pair is added with a opposite sign; and
while receiving a signal formed as a signal with two subcarriers, the received signal is correlated with the known PRN sequence, all the correlations use fragments of the signal from the first half of the pulse, and the known PRN in the first correlations of each pair is correlated with the first subcarrier, and in the second correlations with the second subcarrier, while the correlations in each pair are added with opposite signs, the total results of each pair are added with the same signs, the total result of the first pair is added with a larger weight.

22. The method of claim 21, wherein when receiving BOC-type signal having properties of both single-carrier-generated signals and two-subcarriers-generated signals, the received signal is correlated as a single-carrier-generated signal during some part time and during some other part time it is correlated as a two-subcarriers-generated signal.

23. The method of claim 21, wherein the timing error of a predicted BOC signal arrival time is determined by combining results of both single carrier signals and two-subcarriers signals.

24. The method of claim 21, wherein the timing error of a predicted arrival time of a signal generated with one subcarrier is determined based on the in-phase component of the result divided by the in-phase component of Prompt correlation.

25. The method of claim 21, wherein the timing error of a predicted arrival time of a signal generated with two subcarriers is determined by a not-in-phase component of the result divided by the in-phase component of Prompt correlation.

26. The method of claim 21, wherein a particular timing error is added to a predicted signal arrival time with the corresponding sign, thereby obtaining the specified time of signal arrival.

27. An apparatus comprising a correlator specifying a time of arrival of a radio signal similarly shaped to a known PRN sequence of rectangular pulses, the correlator comprising:
a mixer configured to receive a signal at an input, and transmit two quadrature signals from an output;
a plurality of memory elements each configured to store one of a plurality of coefficients;
a comparison unit having four time thresholds and four states at its output, wherein at the output there is generated a first state, if the input value is less than a first threshold, or at the output there is generated a second state, if the input value is less than a second threshold, or at the output there is generated a third state, if the input value is between a third threshold and a fourth threshold, otherwise, zero state is generated at the output;
a commutation unit configured to select one of the plurality of coefficients or zero depending on the state at the output of the comparison unit;
a Numerically Controlled Oscillator (NCO) configured to count integer and fractional part of a chip number in an epoch;
a fractional extraction module configured to take the fractional part of the chip number and subtracting 0.5 from it, thereby counting time after the front during the first half of the chip from 0 up to +0.5, and during the second chip half from −0.5 up to 0;
a unit configured to calculate modulo of a signed number;
a code generator;
a first multiplier configured to calculate a multiplication product of a code generator's output signal, a mixer's output signal, and a commutation unit's output signal; and
an accumulator configured to accumulate results for one quadrature being chosen, the quadrature chosen being the output of the correlator,
wherein, the output of the first multiplier is added in the accumulator, NCO output is connected to the code generator and to the input of the fractional extraction module, the output of the fractional extraction module is connected to the unit configured to calculate modulo, and its output is fed to the input of the comparison unit.

28. The apparatus of claim 27, further comprising a sign selection mechanism to the input of which the output of the fractional extraction module is fed, the mechanism outputting 1 at negative value at the input, otherwise, 0.

29. The apparatus of claim 28, further comprising a second multiplier calculating the product of the generator code's output, mixer's output, and commutation unit's output, and, in the first multiplier the calculated product is additionally multiplied by a positive subcarrier, and in the second multiplier by a negative subcarrier.

30. The apparatus of claim 29, wherein the output of the second multiplier is summed in the accumulator with a minus sign, the output of the sign selection mechanism being connected to a control input of the accumulator, and, the accumulator adds the result of the product of the first multiplier and subtracts the result of the product of the second multiplier if there is a value of 1 at the control input, otherwise addition and subtraction will not be performed.

31. The apparatus of claim 29, wherein in the first multiplier the calculated product is additionally multiplied by a periodical signal associated to a Hilbert transform of the signal used to generate subcarriers of the received signal.

32. The apparatus of claim 29, wherein the accumulator stores only one quadrature signal.

33. A method for specifying an arrival moment of a radio signal with a known pseudo-random sequence (PRN) of rectangular pulses into a navigation receiver or radar, in which a timing error of a predicted moment of signal arrival is determined by the sum of correlations of six portions of the received signal, calculated as three pair correlations, where each portion corresponds to use in each of the correlations of a certain part of the energy of rectangular pulses and non-use of the signal in this pair correlation for the rest of the time,
wherein,
in the first pair correlation signal two portions adjacent to the pulse boundary are used,
in the second pair correlation two used signal portions are adjacent to portions used in the first pair correlation, and
in the third pair correlation two short portions of the signal are used at a considerable distance from the pulse boundary and from portions used in the first and second pair correlations.

34. The method of claim 33, wherein when receiving a signal formed as a signal with a single carrier, the received signal is correlated with a differentiated version of the known PRN sequence of rectangular pulses, in each pair correlation portions of the signal from the first half of one pulse and the second half of the previous pulse are used, the results of the second and third pair correlation are added with one sign, and the result of the first pair correlation are added with the opposite sign,
whereas when receiving a signal formed as a signal with one or more paired subcarriers, in which paired subcarriers are formed as a result of multiplying the PRN sequence of the rectangular pulses by a modulating signal, the received signal correlates with the known PRN sequence of the rectangular pulses multiplied by the Hilbert transform of the modulating signal, in correlations portions of the signal from the first half of the pulse are used, and the results of each pair correlation are added with the same signs, the total result of the first pair correlation is added with a larger weight.

35. The method of claim 33, wherein in each of the three paired correlations, two equal in energy portions of the pulse are used, which are either a) symmetrically advanced and late relative to the pulse boundary, or b) concentrated on subcarriers symmetrically spaced from the central frequency and are the same fragment of time within the pulse.

36. The method of claim 34, wherein the modulating Hilbert transform is the sum of the Hilbert transform for the modulating signal for positive subcarriers and the modulating Hilbert transform for negative subcarriers.

37. The method of claim 34, wherein when receiving a signal with properties of both single-carrier-generated signal and one-or more paired subcarriers, the timing error of the predicted time of signal arrival is determined by combining results obtained in correlation of the received signal as a signal with single carrier and results obtained in correlation the received signal as a subcarriers-based signal, the calculated timing error being added with the corresponding sign to the predicted time of signal arrival, thereby obtaining the specified time of signal arrival.
